(19) United States
(12) Patent Application Publication
(10) Pub. No.: US 2015/0006277 A1
(43) Pub. Date: Jan. 1, 2015

(54) AD CAMPAIGN MANAGER

(71) Applicant: Airpush, Inc., Los Angeles, CA (US)

(72) Inventor: Asher Delug, Los Angeles, CA (US)

(73) Assignee: Airpush, Inc., Los Angeles, CA (US)

(21) Appl. No.: 14/219,269

(22) Filed: Mar. 19, 2014

Related U.S. Application Data
(60) Provisional application No. 61/840,357, filed on Jun. 27, 2013.

(51) Int. Cl. G06Q 30/02

(52) U.S. Cl. CPC G06Q 30/0244
USPC 705/14.43

(57) ABSTRACT

Technology is disclosed for advertisement campaign management. The technology can gather data associated with an ad campaign across multiple dimensions, and receive one or more user chosen dimensions from the multiple dimensions along with a hierarchy for the one or user chosen dimensions to filter the gathered data by. The technology can filter the gathered data into one or more datasets, where each data set is associated with a corresponding sub-campaign. A particular sub-campaign is associated with a particular combination of dimension values of the one or more user chosen dimensions. The technology can gather, for each sub-campaign corresponding to the one or more datasets, (a) a creative, and (b) a bid amount associated with the particular sub-campaign, where the bid amount is an amount paid for the display of the creative.

### PRIORITY CLAIM

This application claims the benefit of U.S. Provisional Patent Application No. 61/840,357, entitled “AD CAMPAIGN MANAGER”, filed on Jun. 27, 2013, which is incorporated by reference herein in its entirety.

### FIELD

Various of the disclosed embodiments relate to advertising and more particularly, to methods and systems for advertising campaign management.

### BACKGROUND

Today, advertisers who manage ad campaigns, especially campaigns for products with a global market, such as smartphone apps, spend their ad campaign dollars across a variety of marketing channels, both online and offline, all over the globe. Such ad campaigns result in vast amount of campaign related data, making a comprehensive analysis of the ad campaign's effectiveness based on such data a very complex task. Further, even when the complex ad campaign effectiveness analysis could be performed, advertisers have to go through a cumbersome process to implement the changes to the ad campaign in order to achieve their intended goals. So, there is a need for improved techniques for managing and optimizing ad campaigns.

Among teaching a variety of other things, certain aspects of the disclosed technology herein have embodiments which may satisfy one or more of the above-described issues.

### BRIEF DESCRIPTION OF DRAWINGS

These and other objects, features, and characteristics of the disclosed technology will become more apparent to those skilled in the art from a study of the following detailed description in conjunction with the appended claims and drawings, all of which form a part of this specification. In the drawings:

FIG. 1 provides a brief overview of a representative environment in which an advertisement campaign management system can be implemented;

FIG. 2 provides a flowchart of a process implemented by a campaign dashboard module of the advertisement campaign management system;

FIG. 3 provides a flowchart of a process implemented by a optimizer module of the advertisement campaign management system;

FIG. 4 provides an embodiment of a campaign dashboard GUI of the campaign management module;

FIG. 5 provides an embodiment of an optimizer GUI of the optimizer module;

FIG. 6 provides an embodiment of the optimizer GUI of the optimizer module;

FIG. 7 provides an embodiment of the optimizer GUI of the optimizer module, which allow the advertisers to analyze the ad campaign's performance statistics by charting any of the performance statistics over a given time period;

FIG. 8 provides an embodiment of the optimizer GUI of the optimizer module, which allow the advertisers to modify the bid amount associated with a sub-campaign of the ad campaign;

FIG. 9 provides an embodiment of the optimizer GUI of the optimizer module, which allow the advertisers to disable a sub-campaign of the ad campaign;

FIG. 10 provides an embodiment of the optimizer GUI of the optimizer module, which allow the advertisers to modify a creative associated with a sub-campaign of the ad campaign;

FIG. 11 provides an embodiment of the optimizer GUI of the optimizer module, which allow the advertisers to modify a landing page associated with a sub-campaign of the ad campaign; and

FIG. 12 is a high-level block diagram showing an example of the architecture for a computer system.

The headings provided herein are for convenience only and do not necessarily affect the scope or meaning of the claimed invention.

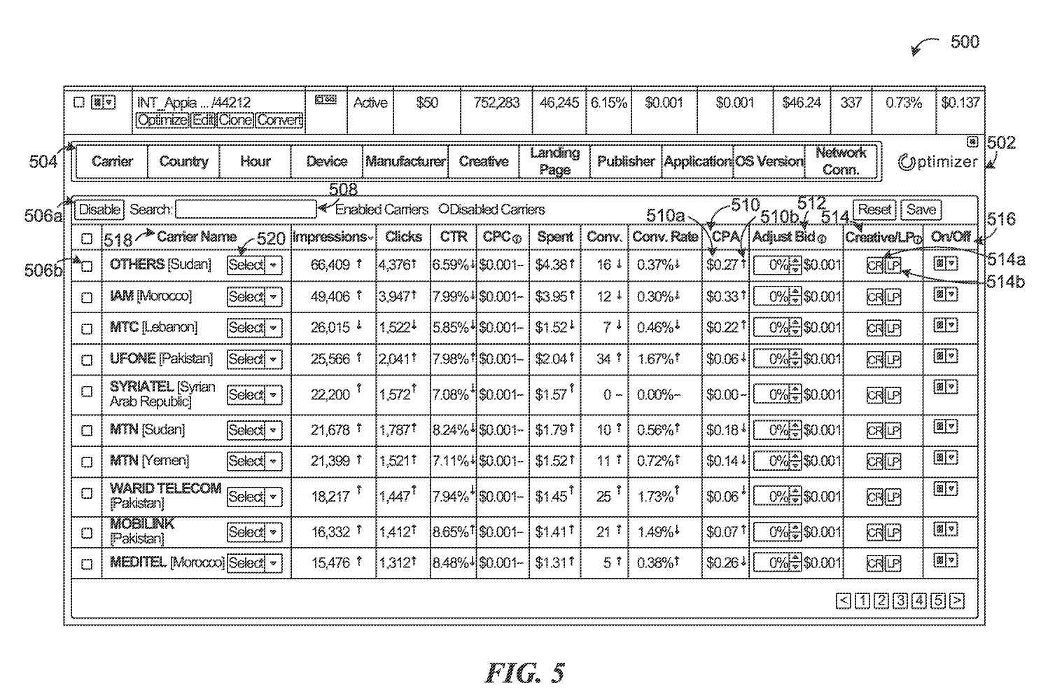

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 504 is first introduced and discussed with respect to FIG. 5).

### DETAILED DESCRIPTION

Technology is disclosed for providing advertisement campaign management (“the technology” or “the disclosed technology”). The disclosed technology gathers data associated with an ad campaign across multiple dimensions, where each dimension has one or more values. The disclosed technology further receives (a) one or more user chosen dimensions from the multiple dimensions, and (b) a hierarchy for the one or user chosen dimensions to filter the gathered data by. The disclosed technology filters the gathered data into one or more datasets, where each data set is associated with a corresponding sub-campaign. A particular sub-campaign is associated with a particular combination of dimension values of the one or more user chosen dimensions.

Additionally, the disclosed technology gathers, for each sub-campaign corresponding to the one or more datasets, (a) a creative, and (b) a bid amount associated with the particular sub-campaign, where the bid amount is an amount paid for the display of the creative. The disclosed technology further provides to a user, at least one of the one or more filtered data sets associated with the particular sub-campaign, where the creative and the bid amount are associated with the particular sub-campaign.

Implementations can include any, all, or none of the following features. Other advantages and features will become apparent from the following description and claims. It should be understood that the description and specific examples are intended for purposes of illustration only and are not intended to limit the scope of the present disclosure.

Various examples of the disclosed technology will now be described. The following description provides specific details for a thorough understanding and enabling description of these examples. One skilled in the relevant art will understand, however, that the disclosed technology may be practiced without many of these details. Likewise, one skilled in the relevant art will also understand that the disclosed technology can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the disclosed technology. Indeed, certain terms may even be emphasized below; however, any terminology intended to be interpreted in any restricted manner will be overtly and specifically defined as such in this Detailed Description section.

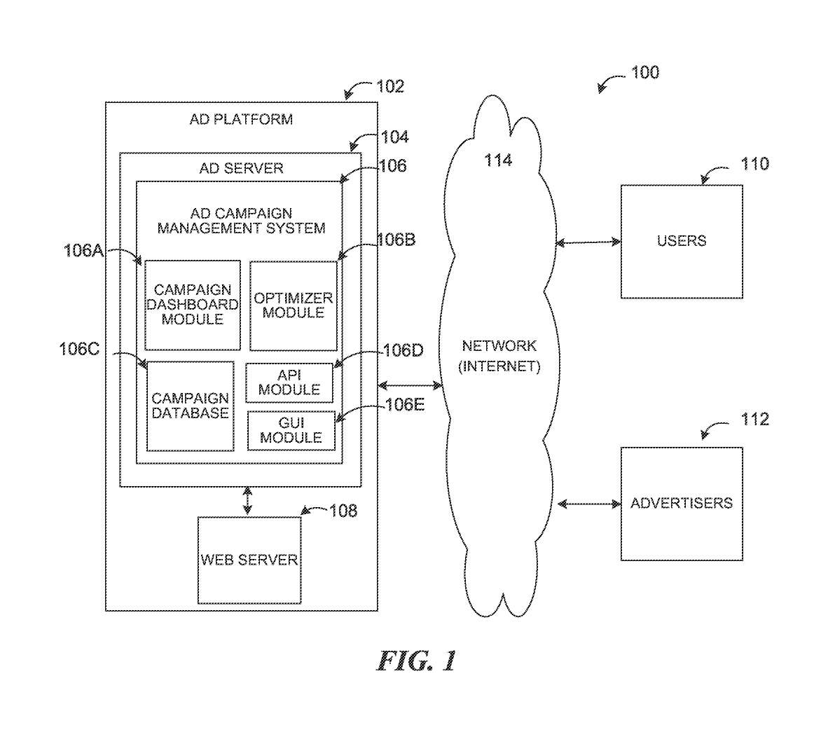

FIG. 1 and the following discussion provide a brief, general description of a representative environment in which the disclosed technology can be implemented. Although not required, aspects of the disclosed technology may be described below in the general context of computer-executable instructions, such as routines executed by a general-purpose data processing device (e.g., a server computer or a personal computer). Those skilled in the relevant art will appreciate that the disclosed technology can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the disclosed technology, such as certain functions, are described as being performed exclusively on a single device, the disclosed technology can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the disclosed technology may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the disclosed technology may be distributed over the Internet or over other networks (including wireless networks) on a propagated signal on a propagation medium (e.g., an electromagnetic wave(s), a sound wave, etc.) over a period of time. In some implementations, the data may be provided on any analog or digital network (packet switched, circuit switched, or other scheme).

FIG. 1 is a diagram of a general environment 100, showing an embodiment of an advertisement (“ad”) platform 102 that may provide analytics and management of an ad campaign. The general environment 100 shown in FIG. 1 is a simplified example of a network ecosystem in which ad campaigns, targeting one or more users 110, may be managed, tracked, and analyzed by one or more advertisers 112 utilizing the ad platform 102. In some instances, the network 114 of the network ecosystem is the Internet, allowing a mobile device (with, for example, WiFi capability) or a personal computer of the users 110 to access ad campaign content offered through various web servers 108. In some instances, especially where the mobile device is used to access web content through the network 114 (e.g., when a 3G or an LTE service of the mobile device is used to connect to the network 114), the network 114 may be any type of cellular, IP-based or converged telecommunications network, including but not limited to Global System for Mobile Communications (GSM), Time Division Multiple Access (TDMA), Code Division Multiple Access (CDMA), etc.

In embodiments, the ad platform 102 tracks and stores the performance of an ad campaign as a set of statistics. In embodiments, the ad platform 102 tracks and stores the ad campaign's performance statistics across different dimensions, where each combination of dimension values correspond to an ad sub-campaign (also simply referred to as sub-campaign) in the overall ad campaign. In embodiments, one of the dimensions could be a country and the value of the dimension could include the names of one or more countries where the ad campaign was carried out.

Another dimension could be manufacturers of smart phones and the value of the dimension could include the names of manufacturers of user smart phones in which the creatives (also simply referred to as ads) of the ad campaign were displayed in. Another dimension could be creatives and the value of the dimension could be the names of creatives associated with the ad campaign, etc. The set of measured statistics could include number of impressions an ad campaign has had across a set of dimensions, the number of clicks by users based on those impressions, the click through rate of the ad campaign, the number of users who took a desired action based on those impressions (also simply referred to as conversions), etc.

In embodiments, the ad platform 102 stores the measured set of statistics in a campaign database 106C, where the stored set of statistics can be used to provide the advertisers with various analytics related to the ad campaign's performance across different dimensions. In embodiments, the ad platform 102 manages one or more user accounts for each of the one or more advertisers 112, where a user account allows an advertiser 112 to track the various ad campaigns managed by the advertiser 112 through the user accounts. In embodiments, the ad platform 102 stores the tracked statistics of the various ad campaigns of the advertiser 112 in association with the user account of the advertiser 112, limiting the access of the tracked statistics of the various ad campaigns of the advertiser 112 to entities accessing the information through the associated user account. It should be noted that the various functionalities of the ad campaign management system have been described from the perspective of the advertiser 112 for illustration purposes only and that the functionalities of the ad campaign management system are in no way limited to just serving the purposes of advertisers.

In embodiments, the ad platform 102 includes an ad server 104 to perform the various analytics on the stored set of statistics and management of the ad campaign. In one embodiment, the ad server 104 may include one or more functional components for enabling management, tracking, optimization and distribution of an ad campaign. In embodiments, the function component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

In one embodiment, the ad server 104 comprises an ad campaign management system 106 to perform the various analytics on the stored set of statistics and management of the ad campaign. In embodiments, the ad campaign management system 106 comprises a campaign management module 106A to facilitate management of advertisers' user accounts and the associated data. In embodiments, the campaign management module 106A provides the advertiser 112 a campaign dashboard in association with the advertiser's 112 user account, where the dashboard includes a synopsis of the one or more ad campaigns that are being managed by the advertiser 112 through that user account. The synopsis includes overall ad campaign related information such as the number of active campaigns being run by the advertiser 112 on the ad platform 102, the number of impressions served through those ad campaigns thus far, amount of money spent, available credit, etc. The synopsis further includes a breakdown of ad campaign related information by the various ad campaigns and their associated statistical metrics of each of the ad campaign.

In embodiments, the campaign management module 106A further allows an advertiser 112 to select any of the listed ad campaigns and perform one or more specific tasks for the selected ad campaign 408. Some of the specific tasks an advertiser 112 can perform in association with a selected ad campaign includes creating a copy of the selected campaign and its various settings for use in conjunction with another campaign, viewing/analyzing the selected ad campaign's effectiveness across various dimensions (discussed in detail later in associated with the optimizer module 106B), optimizing/modifying one or more parameters of a sub-campaign (associated with specific dimensions) within the selected ad campaign, etc. In embodiments, the campaign management module 106A interacts with the optimization module 106B to provide functionalities for viewing/analyzing the selected ad campaign's effectiveness and optimizing/modifying one or more parameters of a sub-campaign within the selected ad campaign.

In the campaign dashboard provided by the campaign management module 106A, the statistical metrics associated with each ad campaign is provided. The statistical metrics of a given ad campaign include information that enable the advertiser to determine the effectiveness of the given ad campaign, where the statistical metrics includes the number of impressions served, the number of clicks received for those served impressions, the click through rate (determined as a function of the number of impressions and the number of clicks received), the current bid amount for each impression, the average cost per click, the total amount of money spent on the ad campaign on the given day, the daily budget of the ad campaign, the number of conversions (i.e., the number of those users who were served ads of the ad campaign performed a desired action), the cost per acquisition (determined as a function of the amount of money spent and the number of conversions, etc.

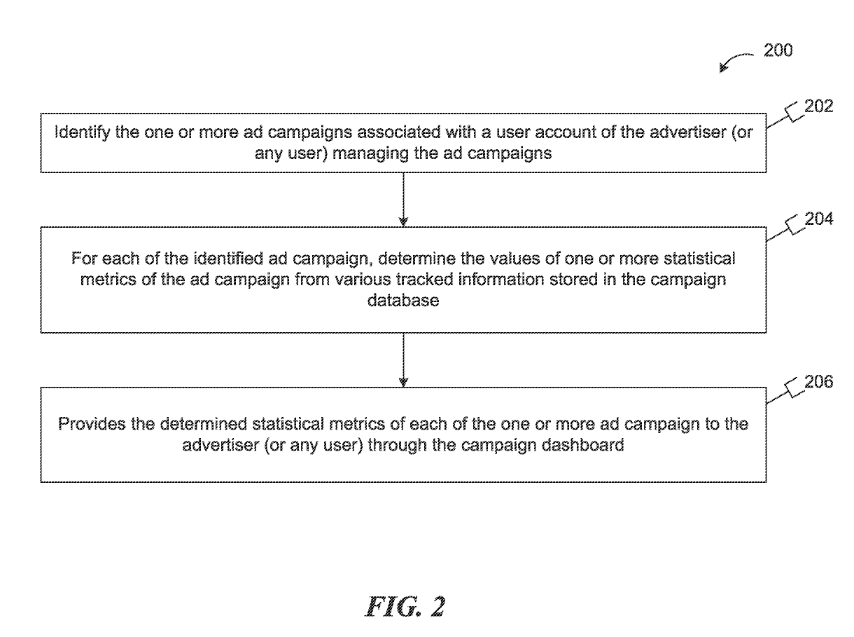

In one embodiment, the campaign dashboard module 106A implements a process 200 that includes the steps 202 through 206, illustrated in FIG. 2, to provide the advertisers 112 the various ad campaign related information. At step 202, the campaign dashboard module 106A identifies the one or more ad campaigns associated with a user account of the advertiser 112 (or any user) managing the ad campaigns. At step 204, for each of the identified ad campaign, the campaign dashboard module 106A determines the values of one or more statistical metrics of the ad campaign from the ad campaign's various tracked information stored in the campaign database 106C. At step 206, the campaign dashboard module 106A provides the determined statistical metrics of each of the one or more ad campaign to the advertiser 112 (or any user) through the campaign dashboard. In embodiments, the ad management system 106 includes various Application Program Interface (“API”) module 106D and Graphical User Interface (“GUI”) module 106E to enable Advertisers 112 and other entities to interact with the ad management system 106 and its various functional modules, such as campaign management module 106A, the optimizer module 106B, the campaign database 106C (either directly or indirectly through the other functional modules of the ad management system 106), etc.

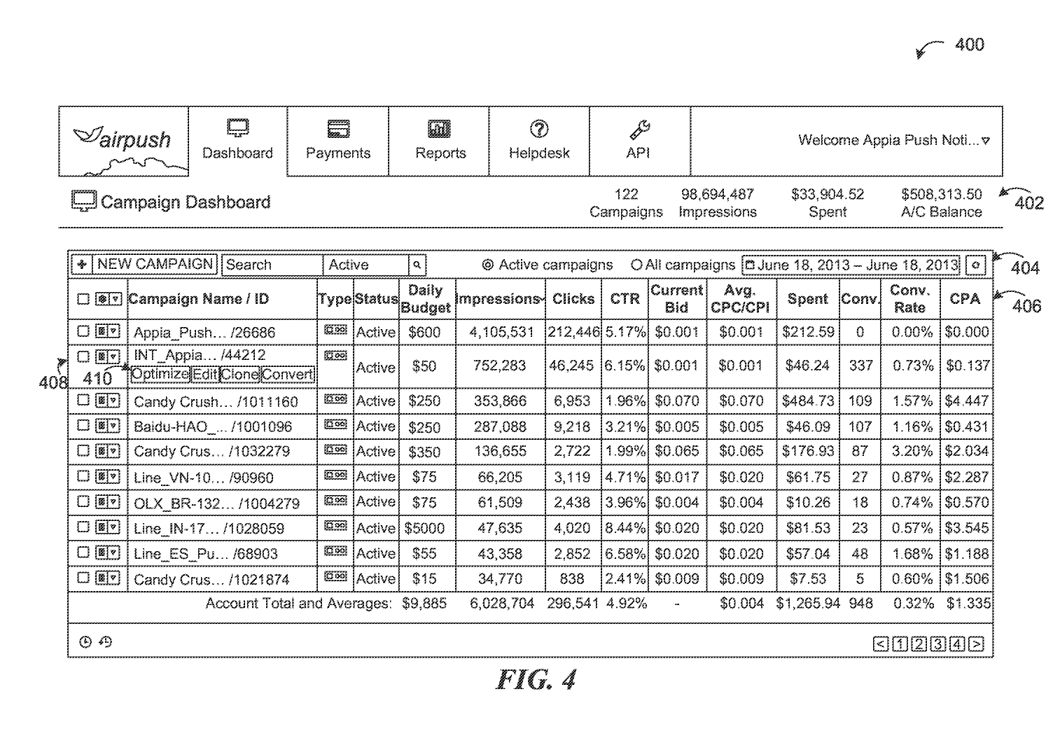

FIG. 4 provides an embodiment of a campaign dashboard GUI 400 of the campaign management module 106A, which provides the advertisers 112 and other entities a synopsis of the one or more ad campaigns that are being managed by the advertiser 112 through a particular user account. In FIG. 4, the GUI 400 provides an overall ad campaign performance synopsis 402 such as total number of campaigns, total impressions served, etc. The GUI 400 further provides a breakdown 404 of the various ad campaigns associated with the user account and the associated statistical metrics 406 of each of the ad campaign over a specific time period. As discussed above, the statistical metrics associated with the ad campaigns include information such as the number of impressions served, the number of clicks received for those served impressions, the click through rate, etc.

The GUI 400 further allows an advertiser 112 to select any of the listed ad campaigns, such as the “INT_Appia . . . ” campaign 408, and perform one or more specific tasks for the selected ad campaign 408. As discussed earlier, some of the specific tasks an advertiser 112 can perform in association with a selected ad campaign 408 includes creating a copy of the selected campaign 408 and its various settings for use in conjunction with another campaign, viewing the selected ad campaign's 408 effectiveness across various dimensions (discussed in detail later in associated with the optimizer module 106B), optimizing/modifying one or more parameters of a sub-campaign (associated with specific dimensions) within the selected ad campaign 408, etc.

As discussed above, the campaign management module 106A, associated with the GUI 400, interacts with the optimization module 106B to provide functionalities for viewing/analyzing the selected ad campaign's 408 effectiveness and optimizing/modifying one or more parameters of a sub-campaign within the selected ad campaign. In GUI 400, the button 410, named “Optimize”, is provided, which when clicked invokes the GUI 500 of the optimization module 106B to provide functionalities for viewing/analyzing the selected ad campaign's 408 effectiveness and optimizing/modifying one or more parameters of a sub-campaign within the selected ad campaign.

In embodiments, the optimizer module 1068 allows the advertiser 112 to analyze the selected ad campaign's 408 effectiveness by filtering the statistical metrics of the selected ad campaign 408 into one or more sub-campaigns, where each sub-campaign is associated with a particular combination of dimensions. As discussed above, in embodiments, the ad platform 102 tracks and stores the ad campaign's performance statistics across different dimensions in the campaign database 106C, where each combination of dimension values is associated with a particular sub-campaign.

In embodiments, one of the dimensions could be a country and the value of the dimension could include the names of one or more countries where the ad campaign was carried out. Here, the captured statistics for the country dimension corresponds to the ad campaign's performance in each of the one or more country where the ad campaign was carried out. Another dimension could be manufacturers of smart phones and the value of the dimension could include the names of manufacturers of user smart phones in which the creatives (also simply referred to as ads) of the ad campaign were displayed in. Another dimension could be creatives and the value of the dimension could be the names of creatives associated with the ad campaign, etc. Another dimension could be landing page and the value of the dimension could be the various landing pages associated with the various creatives of the ad campaign, etc.

The dimension could also include an application dimension (e.g., a smartphone application) and the value of the application dimension could include the names of the applications (e.g., names of smartphone applications) within which creatives of the ad campaign were displayed in. Yet another dimension could be a unit of time, e.g., hour, and the value of the dimension could include all the timestamps in increments of the unit of time and the statistics corresponds to the campaign's performance between each given timestamp.

Other dimensions could include a data provider (such as wireless service provider), a device model (e.g., a smart phone model), a publisher of application (where the publishers are producers of applications within which the creatives of ad campaign were displayed in), an Operating System (“OS”) version (associated with the OS of the device), a network connection type (i.e. connection type used to connect the device, e.g., 3G, 4G, LTE, etc., within which the creatives of ad campaign were displayed in). The above discussed dimensions are merely provided to give an idea about what a dimension could be and therefore, should not be considered to be limiting the scope of the disclosed technology to just those disclosed dimensions.

As discussed above, the ad platform 102 tracks and stores the ad campaign's performance statistics across different dimensions, where each combination of dimension values correspond to an ad sub-campaign (also simply referred to as sub-campaign) in the overall ad campaign. For a given sub-campaign, the set of measured performance statistics could include number of impressions achieved by the sub-campaign, the number of clicks by users based on those impressions, the click through rate of the ad campaign, the number of users who took a desired action based on those impressions (also simply referred to as conversions), the current bid amount for each impression, the average cost per click, the total amount of money spent on the ad campaign on the given day, the daily budget of the ad campaign, the number of conversions (i.e., the number of those users who were served ads of the ad campaign performed a desired action), the cost per acquisition (determined as a function of the amount of money spent and the number of conversions, etc.

In embodiments, the optimizer module 106B allows an advertiser 112 to analyze the ad campaign's performance statistics across a subset of chosen sub-campaigns. In embodiments, the optimizer module 106B allows the advertiser 112 to choose the subset of sub-campaigns by selecting a combination of dimension values that correspond to the subset of sub-campaigns the advertiser 112 is interested in. In embodiments, the optimizer module 1066 allows the advertiser 112 to select a value for one or more of the various dimensions associated with the stored data while allowing the remaining dimensions for which no specific value was selected by the advertiser 112 to a default value. In embodiments, the default value can be all the values of the dimension or be a specific value of the dimension.

For example, the set of dimensions associated with an ad campaign can be country, carrier, and device model. An advertiser can choose a specific subset of sub-campaigns of the ad campaign but just setting the value of country dimension to “USA” and the value of the “Verizon” while leaving the value of the device model dimension to default (which in this case is set to “all”). The chosen subset of sub-campaigns will include all the sub-campaigns with associated dimension values that correspond to “USA” for country, “Verizon” for carrier and any value associated with device model dimension.

In embodiments, the optimizer module 106B allows the advertiser 112 to provide a dimension hierarchy for the various dimensions of the ad campaign to aggregate the performance statistics of the ad campaign in a particular order. For example, the advertiser 112 could provide a dimension hierarchy with country as the first dimension, the device model as the second dimension and the carrier as the third dimension. The optimizer module 106B would then aggregate the performance statistics of the ad campaign by first filtering it by country, then each country data by device model, and finally each device model data by carrier.

In embodiments, the optimizer module 106B allows the advertiser 112 to provide a dimension hierarchy for a subset of the various dimensions of the ad campaign, allowing the performance statistics of the ad campaign to be aggregated along just the hierarchy of the subset of dimensions. For the above example, the advertiser 112 could provide a dimension hierarchy with country as the first dimension and the device model as the second dimension while leaving the carrier dimension from the hierarchy. The optimizer module 106B then aggregates the performance statistics of the ad campaign by first filtering it by country and then each country data by device model. However, the data will be not be further filtered according to the carrier dimension. In embodiments, the optimizer module 106B utilizes the dimensions for which the advertiser 112 sets a value and the order in which the advertiser 112 sets the value for the subset of dimensions to determine the subset of chosen dimensions and the hierarchy of the subset of chosen dimensions respectively.

As discussed above, each combination of dimension values correspond to a sub-campaign in the overall ad campaign. Further, as discussed above, in embodiments, the optimizer module 106B allows the advertiser 112 to set values for a subset of dimensions associated with the ad campaign and allow the rest to a default value. In embodiments, where the default value of a dimension is set to “all” and the dimension has more than one value, the optimizer module 106B, then, provides the advertiser 112 with a subset of sub-campaigns that correspond to each of the combination of dimension values. As discussed above, in embodiments, the performance statistics of the selected subset of sub-campaigns is filtered according to the set of dimensions chosen and the hierarchy of the chosen dimensions.

In embodiments, the optimizer module 1068 allows the advertiser 112 to modify one or more parameters of a given sub-campaign to alter the effectiveness of the sub-campaign. The optimizer module 106B thus allows the advertisers to optimize the overall effectiveness of an ad campaign by optimizing the sub-campaigns of the ad campaign. The one or more parameters could include the bid amount to pay for the display of a creative associated with the given sub-campaign, the creative associated the sub-campaign, the landing page associated with the creative of the sub-campaign (where, for example, a user action in response to the creative takes the user to the associated landing page), etc.

In embodiments, the optimizer module 106B allows the advertiser 112 to disable the given sub-campaign, preventing the ad platform 102 from spending any portion of the ad budget on the given sub-campaign. For example, when the advertiser 112 disables a sub-campaign with Canada as the country dimension and iPhone as the manufacturer dimension, then the ad platform 102 stops advertising the ad campaign's ads to any iPhone users in Canada. However, unless otherwise disabled, the ad platform 102 can continue targeting other users with the ad campaign's ads, including any mobile phone user in Canada who does not use an iPhone. So, by modifying sub-campaigns, the optimizer module 106B allows the advertisers to optimize the overall effectiveness of the ad campaign. Further, as discussed above, the advertiser 112 can select and analyze a subset of sub-campaigns. In embodiments, the optimizer module 1068 allows the advertiser 112 to apply the modification of the one or more parameters to a subset of chosen sub-campaigns to alter the effectiveness of the entire subset of sub-campaigns.

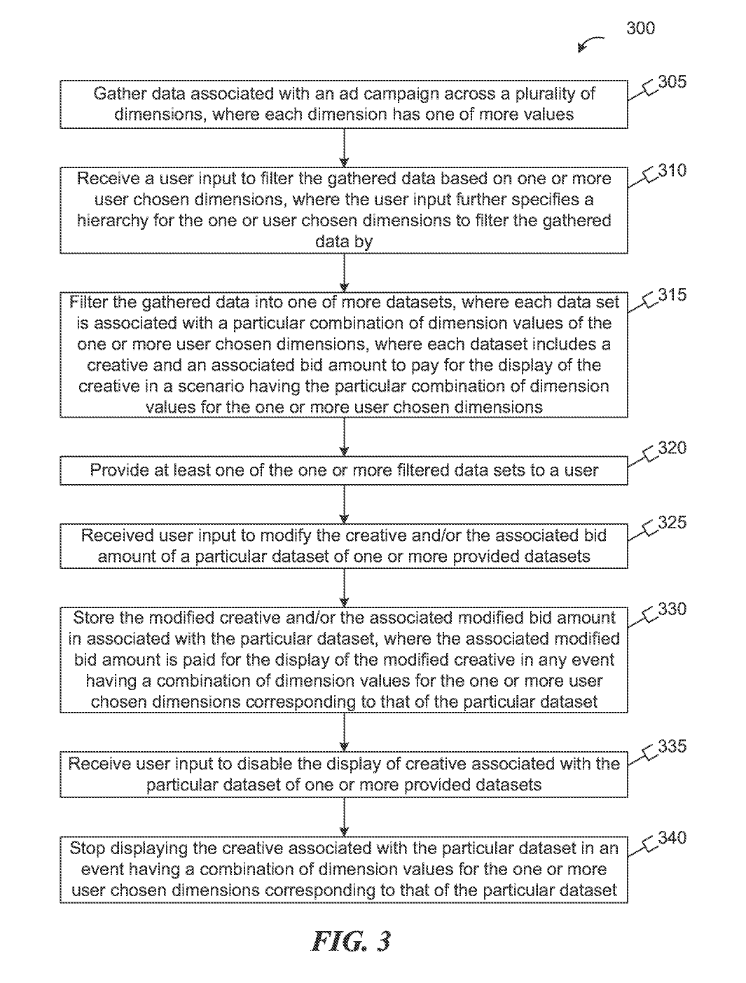

In one embodiment, the optimizer module 106B implements a process 300 that includes the steps 305 through 345, illustrated in FIG. 3, to allow the advertisers 112 to analyze the ad campaign's performance statistics by filtering into sub-campaigns and managing/optimizing the ad campaign by modifying the sub-campaigns. At step 305, the optimizer module 106B gathers data associated with an ad campaign across a plurality of dimensions, where each dimension has one or more values. At step 310, the optimizer module 106B receives one or more dimensions chosen by a user and a hierarchy for the one or dimensions chosen by the user to filter the gathered data by. At step 315, the optimizer module filters the gathered data into one or more datasets, where each dataset is associated with a corresponding sub-campaign, where a particular sub-campaign is associated with a particular combination of dimension values of the one or more user chosen dimensions. At step 320, for each sub-campaign, the optimizer module 106B identifies and gathers a creative and an associated bid amount to pay for the display of the creative, which are associated with the sub-campaign.

At step 325, the optimizer module 106B provides at least one of the one or more filtered data sets associated with a particular sub-campaign, the creative, and the associated bid amount of the particular sub-campaign are provided to the user. At step 330, the optimizer module 106B receive user input to modify the creative and/or the associated bid amount of the particular sub-campaign. At step 335, the optimizer module 106B stores the modified creative and/or the modified bid amount in association with the particular sub-campaign, where the modified bid amount will be paid by the particular sub-campaign for the display of the modified creative. At step 340, the optimizer module 106B receives user input to disable the particular sub-campaign. At step 345, the optimizer module 106B, through the ad platform 102, stops displaying the modified creative associated with the particular sub-campaign.

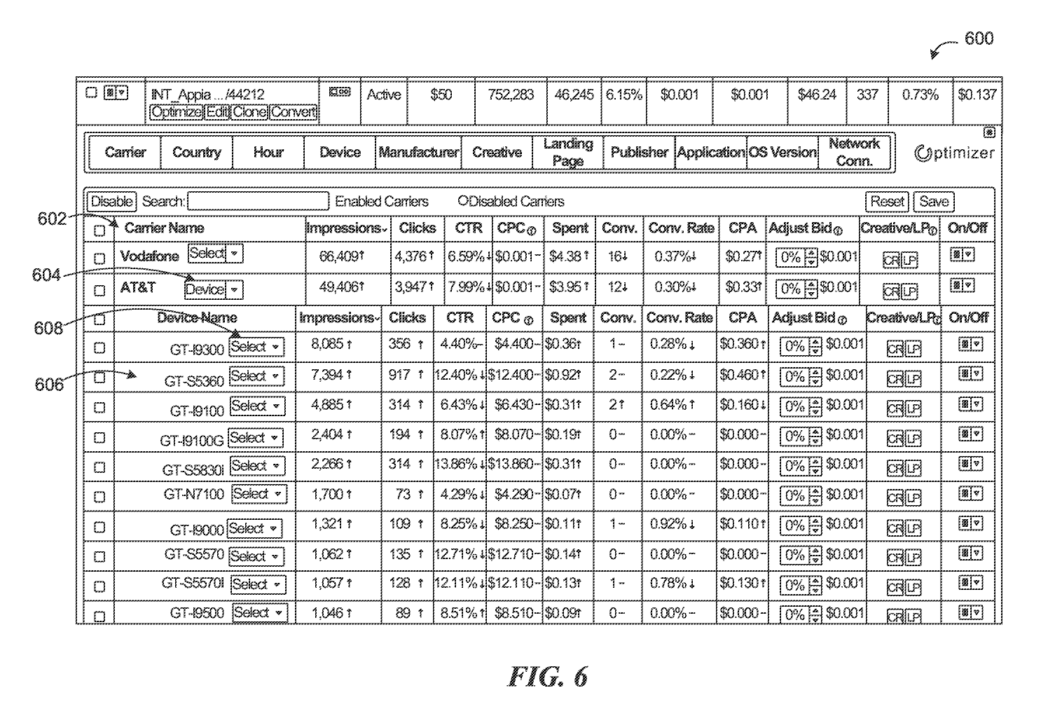

FIG. 5 provides an embodiment of an optimizer GUI 500 of the optimizer module 1068, which allow the advertisers 112 to interact with the optimizer module 1068 to analyze the ad campaign's performance statistics by filtering into sub-campaigns and managing/optimizing the ad campaign by modifying the sub-campaigns. In FIG. 5, the GUI 500 provides a list 502 of all the dimensions associated with the ad campaign. The GUI 500 further provides a list of all the sub-campaigns 504 associated with the carrier dimension (chosen by the advertiser 112 by clicking on the carrier dimension on the provided dimension list 502), where the various sub-campaigns are those associated with the names of different carriers 508 through whom the creatives of the ad campaign where displayed. Within each sub-campaign based on carrier name 508, the GUI 500 provides the advertiser 112 a “select” button 518 to allow the advertiser 112 to select any of the remaining dimension (i.e. dimensions other than carrier) and analyze the data by sub-campaigns associated with the a specific carrier name and the chosen dimension using button 518. The multi-dimensional feature to break the ad campaign into many sub-campaigns is further explained in FIG. 6.

The GUI 500 further provides the ability for the advertiser 112 to disable any of the sub-campaigns by selecting 506b the sub-campaign and clicking on the “Disable” button 506a. The GUI 500 also provides the various performance statistics of each of the sub-campaign, such as cost per acquisition (“CPA”) 510, clicks, etc. For each performance statistics, the GUI 500 not only provides its value 510a but also an indicator 510b to indicate whether the value increased or decreased over a previous period when the sub-campaign was in progress. Further, the GUI 500 provides an adjust bid amount column 512 and creative/landing page column 514 with each sub-campaign, which the advertiser 112 can utilize to optimize the bid amount or modify the creative 514a or the landing page 514b associated with the sub-campaign. The GUI 500 also provides an on/off switch 516 to disable any given sub-campaign.

FIG. 6 provides an embodiment of an optimizer GUI 600 of the optimizer module 106B, which allow the advertisers 112 to analyze the ad campaign's performance statistics by filtering into sub-campaigns using the various dimensions of the ad campaign and managing/optimizing the ad campaign by modifying the sub-campaigns. In GUI 600, the sub-campaigns are first filtered by carrier dimension 602 (as explained above), where each line represents a subset of sub-campaigns associated with a particular carrier name, e.g., Vodafone, AT&T, etc., (and default values for the other dimensions). The subset of sub-campaigns can be further filtered by selecting one of the other dimensions using the “select” drop-down button.

In GUI 600, the subset of sub-campaigns associated with the AT&T carrier is further filtered by device dimension 604, resulting in a subset of sub-campaigns with AT&T carrier dimension and device dimension (with name of various device models 606 as value). Again, each of the subset of sub-campaigns associated with AT&T carrier dimension and a particular device name (e.g., GT-19300) can be further filtered by selecting one of the remaining dimensions using the “select” drop-down button 608. The ad campaign can thus be filtered into subsets of sub-campaigns which can be analyzed and modified to alter the overall effectiveness of the ad campaign.

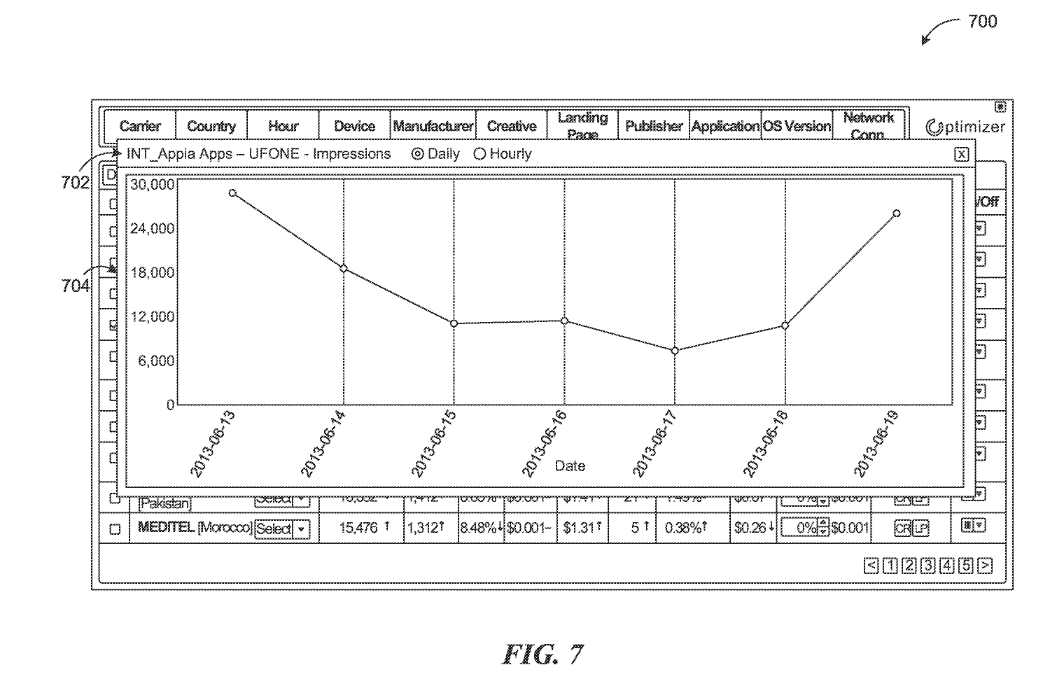

FIG. 7 provides an embodiment of an optimizer GUI 700 of the optimizer module 106B, which allow the advertisers 112 to analyze the ad campaign's performance statistics by charting any of the performance statistics over a given time period. In GUI 700, performance statistics relating to the number of impressions provided 602 for the subset of sub-campaigns associated with carrier dimension “UFONE” of the ad campaign “INT_Appia Apps” is charted 604 over a given period of time from the current date.

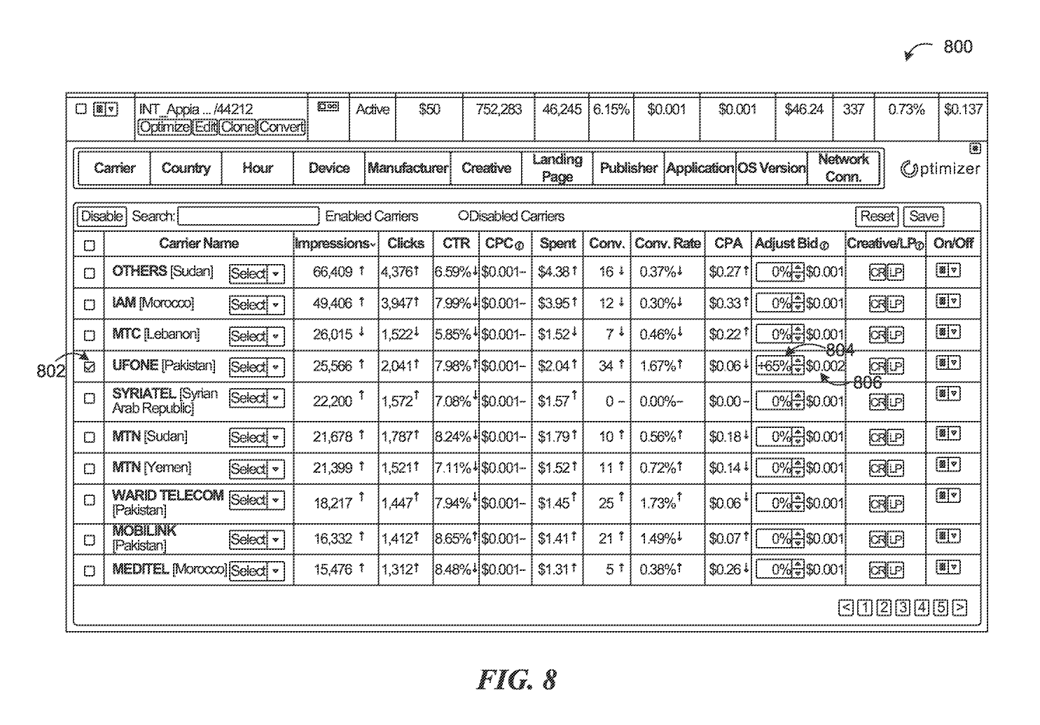

FIG. 8 provides an embodiment of an optimizer GUI 800 of the optimizer module 1066, which allow the advertisers 112 to modify the bid amount associated with a sub-campaign of the ad campaign. In GUI 800, the bid amount 806 associated with subset of sub-campaigns with “UFONE” carrier dimension is adjusted by using the increment/decrement counter tab 804.

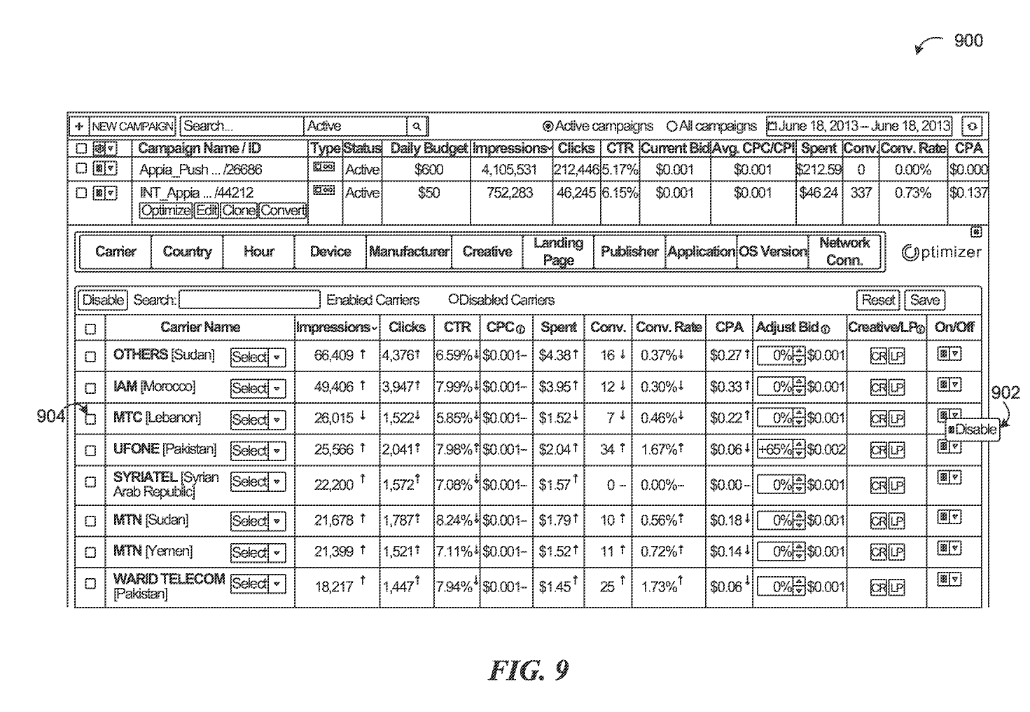

FIG. 9 provides an embodiment of an optimizer GUI 900 of the optimizer module 106B, which allow the advertisers 112 to disable a sub-campaign of the ad campaign. In GUI 900, the subset of sub-campaigns with “MTC[Lebanon]” carrier dimension 904 are disabled by the advertiser 112 by using the on/off associated disable tab 902.

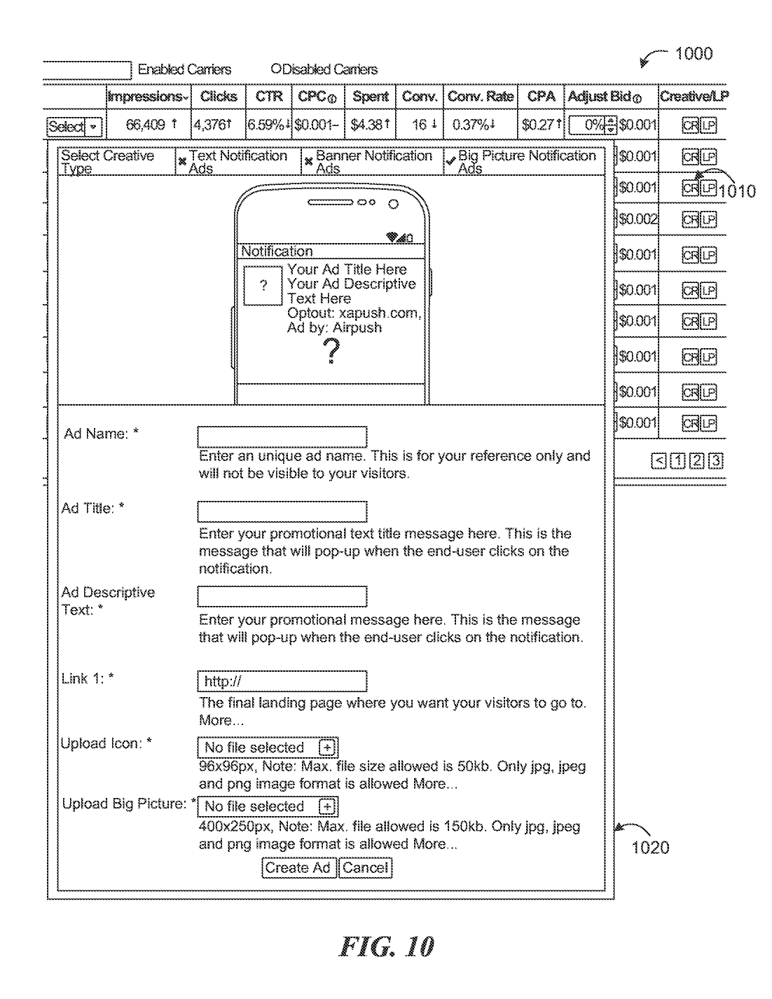

FIG. 10 provides an embodiment of an optimizer GUI 1000 of the optimizer module 1066, which allow the advertisers 112 to modify a creative associated with a sub-campaign of the ad campaign. In GUI 1000, a new creative can be associated with a subset of sub-campaigns by the advertiser 112 by clicking on the “CR” 1010 button. In GUI 1000, a new pop-up GUI 1020 is provided to the advertiser 112, which guides the advertiser 112 through choosing and associating a new creative with the subset of sub-campaigns.

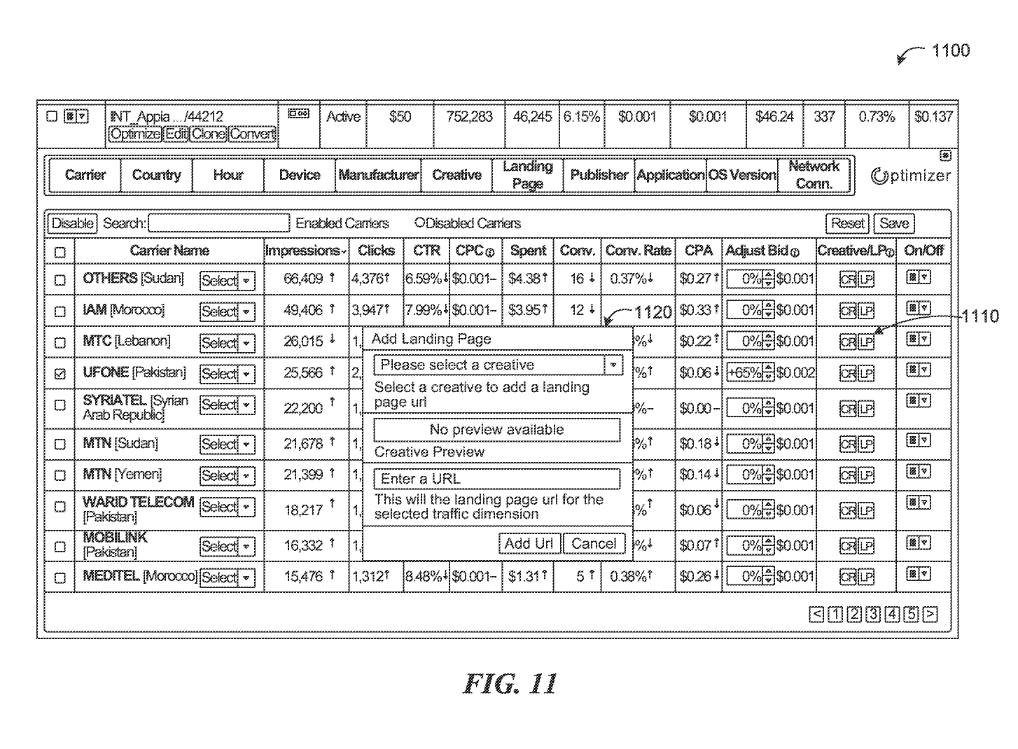

FIG. 11 provides an embodiment of an optimizer GUI 1100 of the optimizer module 1066, which allow the advertisers 112 to modify a landing page associated with a sub-campaign of the ad campaign. In GUI 1100, a new landing page can be associated with a subset of sub-campaigns by the advertiser 112 by clicking on the “LP” 1110 button. In GUI 1100, a new pop-up GUI 1120 is provided to the advertiser 112, which guides the advertiser 112 through choosing and associating a new landing page with the subset of sub-campaigns.

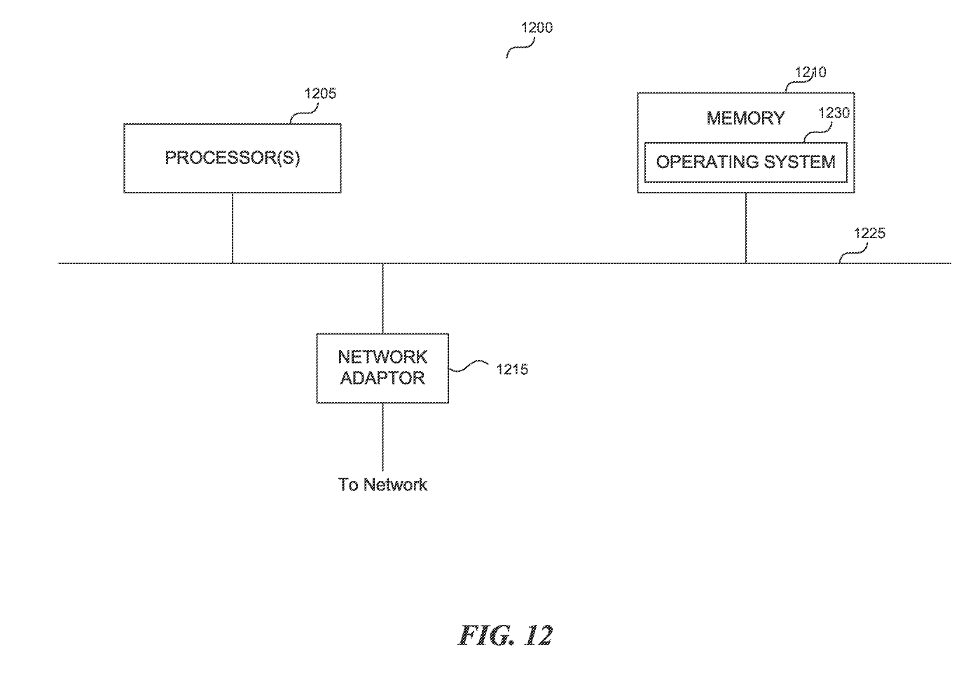

FIG. 12 is a high-level block diagram showing an example of the architecture for a computer system 1200 that can be utilized to implement an advertisement server (e.g., 104 from FIG. 1), a web server (e.g., 108 from FIG. 1), etc. In FIG. 12, the computer system 1200 includes one or more processors 1205 and memory 1210 connected via an interconnect 1225. The interconnect 1225 is an abstraction that represents any one or more separate physical buses, point to point connections, or both connected by appropriate bridges, adapters, or controllers. The interconnect 1225, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1294 bus, sometimes referred to as “Firewire.”

The processor(s) 1205 may include central processing units (CPUs) to control the overall operation of, for example, the host computer. In certain embodiments, the processor(s) 1205 accomplish this by executing software or firmware stored in memory 1210. The processor(s) 1205 may be, or may include, one or more programmable general-purpose or special-purpose microprocessors, digital signal processors (DSPs), programmable controllers, application-specific integrated circuits (ASICs), programmable logic devices (PLDs), or the like, or a combination of such devices.

The memory 1210 is or includes the main memory of the computer system 1200. The memory 1210 represents any form of random access memory (RAM), read-only memory (ROM), flash memory (as discussed above), or the like, or a combination of such devices. In use, the memory 1210 may contain, among other things, a set of machine instructions which, when executed by processor 1205, causes the processor 1205 to perform operations to implement embodiments of the disclosed technology.

Also connected to the processor(s) 1205 through the interconnect 1225 is a network adapter 1215. The network adapter 1215 provides the computer system 1200 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further, any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the disclosed technology.

Any patents and applications and other references noted above, including any that may be listed in accompanying filing papers, are incorporated herein by reference. Aspects of the disclosed technology can be modified, if necessary, to employ the systems, functions, and concepts included in such references to provide further implementations of the disclosed technology.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system may vary considerably in its specific implementation, while still being encompassed by the disclosed technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms. Accordingly, the actual scope of the disclosed technology encompasses not only the disclosed examples, but also all equivalent ways of practicing or implementing the disclosed technology under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶7 will begin with the words “means for.”) Accordingly, the applicant reserves the right to add additional claims after filing the application to pursue such additional claim forms for other aspects of the invention.

We claim:

1. A method, comprising:
gathering, by a computing system, data associated with an ad campaign across a plurality of dimensions, wherein each dimension has one or more values;
receiving, by the computing system, (a) a one or more user chosen dimensions from the plurality of dimensions, and (b) a hierarchy for the one or user chosen dimensions to filter the gathered data by;
filtering, by the computing system, the gathered data into one or more datasets, wherein each data set is associated with a corresponding sub-campaign, wherein a given sub-campaign is associated with a given combination of dimension values of the one or more user chosen dimensions;
for each sub-campaign corresponding to the one or more datasets, gathering, by the computing system, (a) a creative, and (b) a bid amount associated with the given sub-campaign, the bid amount being an amount paid for the display of the creative; and
providing, by the computing system, to a user, at least one of the one or more filtered data sets associated with a particular sub-campaign, the creative associated with the particular sub-campaign, and the bid amount associated with the particular sub-campaign.

2. The method of claim 1, further comprising:
receiving, by the computing system, a user input to modify the creative associated the particular sub-campaign, the user input including a modified creative; and
storing, by the computing system, the modified creative in association with the particular sub-campaign, wherein the bid amount is paid for a display of the modified creative associated with the particular sub-campaign.

3. The method of claim 1, further comprising:
receiving, by the computing system, a user input to modify the bid amount associated the particular sub-campaign, the user input including a modified bid amount; and
storing, by the computing system, the modified bid amount in association with the particular sub-campaign, wherein the modified bid amount is paid for a display of the creative associated with the particular sub-campaign.

4. The method of claim 1, further comprising:
receiving, by the computing system, a user input to disable the particular sub-campaign; and
disabling, by the computing system, display of the creative associated with the particular sub-campaign.

5. The method of claim 1, wherein a given dimension includes a country, wherein a value of the country dimension includes names of one or more countries being reached by the ad campaign.

6. The method of claim 1, wherein a given dimension includes a data carrier, wherein a value of the data carrier dimension includes names of one or more wireless service providers utilized by one or more users being reached by the ad campaign.

7. The method of claim 1, wherein a given dimension includes:
a country;
a data carrier;
a time;
a communication device manufacturer;
a communication device model;
a software application;
an operating system;
a network connection type;
a creative;
a landing page associated with the creative; or
a publisher associated with the software application.

8. The method of claim 1, wherein a given dataset includes one or more performance statistics for measuring effectiveness of a given sub-campaign, the one or more performance statistics includes:
a total number of impressions achieved;
a number of clicks received;
a click through rate;
a cost per click;
an amount spent for achieving the total number of impressions;
a total number of conversions;
a conversion rate; or
a cost per acquisition.

9. A system, comprising:
at least one memory storing computer-executable instructions; and
at least one processor configured to access the at least one memory and execute the computer-executable instructions to perform a set of acts, the acts including:
gathering data associated with an ad campaign across a plurality of dimensions, wherein each dimension has one or more values;
receiving (a) a one or more user chosen dimensions from the plurality of dimensions, and (b) a hierarchy for the one or user chosen dimensions to filter the gathered data by;
filtering the gathered data into one or more datasets, wherein each data set is associated with a corresponding sub-campaign, wherein a given sub-campaign is associated with a given combination of dimension values of the one or more user chosen dimensions;
for each sub-campaign corresponding to the one or more datasets, gathering (a) a creative, and (b) a bid amount associated with the given sub-campaign, the bid amount being an amount paid for the display of the creative; and
providing to a user, at least one of the one or more filtered data sets associated with a particular sub-campaign, the creative associated with the particular sub-campaign, and the bid amount associated with the particular sub-campaign.

10. The system of claim 9, the acts further including:
receiving a user input to modify the creative associated the particular sub-campaign, the user input including a modified creative; and
storing the modified creative in association with the particular sub-campaign, wherein the bid amount is paid for a display of the modified creative associated with the particular sub-campaign.

11. The system of claim 9, the acts further including:
receiving a user input to modify the bid amount associated the particular sub-campaign, the user input including a modified bid amount; and
storing the modified bid amount in association with the particular sub-campaign, wherein the modified bid amount is paid for a display of the creative associated with the particular sub-campaign.

12. The system of claim 9, the acts further comprising:
receiving a user input to disable the particular sub-campaign; and
disabling display of the creative associated with the particular sub-campaign.

13. The system of claim 9, wherein a given dimension includes a country, wherein a value of the country dimension includes names of one or more countries being reached by the ad campaign.

14. The system of claim 9, wherein a given dimension includes a data carrier, wherein a value of the data carrier dimension includes names of one or more wireless service providers utilized by one or more users being reached by the ad campaign.

15. The system of claim 1, wherein a given dimension includes:
a country;
a data carrier;
a time;
a communication device manufacturer;
a communication device model;
a software application;
an operating system;
a network connection type;
a creative;
a landing page associated with the creative; or
a publisher associated with the software application.

16. The system of claim 1, wherein a given dataset includes one or more performance statistics for measuring effectiveness of a given sub-campaign, the one or more performance statistics includes:
a total number of impressions achieved;
a number of clicks received;
a click through rate;
a cost per click;
an amount spent for achieving the total number of impressions;
a total number of conversions;
a conversion rate; or
a cost per acquisition.

17. A computer readable storage medium storing computer executable instructions, comprising:
instructions for gathering data associated with an ad campaign across a plurality of dimensions, wherein each dimension has one or more values;
instructions for receiving (a) a one or more user chosen dimensions from the plurality of dimensions, and (b) a hierarchy for the one or user chosen dimensions to filter the gathered data by;
instructions for filtering the gathered data into one or more datasets, wherein each data set is associated with a corresponding sub-campaign, wherein a given sub-campaign is associated with a given combination of dimension values of the one or more user chosen dimensions;
for each sub-campaign corresponding to the one or more datasets, instructions for gathering (a) a creative, and (b) a bid amount associated with the given sub-campaign, the bid amount being an amount paid for the display of the creative; and
instructions for providing to a user, at least one of the one or more filtered data sets associated with a particular sub-campaign, the creative associated with the particular sub-campaign, and the bid amount associated with the particular sub-campaign.
